(19) United States
(12) Patent Application Publication
(10) Pub. No.: US 2021/0097543 A1
(43) Pub. Date: Apr. 1, 2021

(54) DETERMINING FRAUD RISK INDICATORS USING DIFFERENT FRAUD RISK MODELS FOR DIFFERENT DATA PHASES

(71) Applicant: Microsoft Technology Licensing, LLC, Redmond, WA (US)

(72) Inventors: Yuting JIA, Redmond, WA (US); Qizhi CUI, Bothell, WA (US); Kiyoung YANG, Sammamish, WA (US); Hang XU, Kenmore, WA (US); Hui SUN, Bellevue, WA (US); Yiqing WANG, Bellevue, WA (US); Jayaram NM NANDURI, Issaquah, WA (US)

(21) Appl. No.: 16/745,193

(22) Filed: Jan. 16, 2020

Related U.S. Application Data
(60) Provisional application No. 62/908,311, filed on Sep. 30, 2019.

(51) Int. Cl. G06Q 20/40; G06N 20/00; G06K 9/62

(52) U.S. Cl. CPC G06Q 20/4016; G06K 9/6227; G06N 20/00

(57) ABSTRACT

Different fraud risk models can be developed and applied for a consortium of e-commerce merchants. With this multi-phase modeling strategy, a consortium member can get its optimal model performance at different data phases from an early phase where the consortium member does not have any historical data, to a more mature phase where the consortium member has a short time period of matured data, to a fully mature phase where the consortium member has a long-time period of matured data. On the other hand, the matured consortium data is not affected by the immature data from new members. Thus, the model performance for long-time existing members is not affected by new members at immature phases.

### CROSS-REFERENCE TO RELATED APPLICATIONS

This application is related to and claims the benefit of U.S. Provisional Patent Application No. 62/908,311 filed on Sep. 30, 2019 (Attorney Docket No. 407512-US-PSP). The aforementioned application is expressly incorporated herein by reference in its entirety.

### BACKGROUND

Electronic commerce, or “e-commerce,” is the activity of buying or selling of goods or services using the Internet and the transfer of money and data to execute these transactions. E-commerce fraud occurs when a criminal leverages stolen payment information (e.g., fraudulently acquired credit or debit card numbers) to attempt e-commerce transactions without the account owner's knowledge.

For various reasons, including the threat of chargebacks (i.e., the return of funds by a seller to a buyer's debit or credit card account), e-commerce merchants have significant incentives to prevent fraudulent transactions from occurring. Some e-commerce merchants have started to use machine learning models to attempt to prevent e-commerce fraud. In general terms, machine learning algorithms discover patterns in data, and construct mathematical models using these discoveries. The models can then be used to make predictions on future data. In the context of fraud prevention, one possible application of a machine learning model would be to predict the likelihood that a proposed transaction is fraudulent based on various information associated with the transaction and mostly also based on historical information. A machine learning model that can be used to assess the risk that e-commerce transactions are fraudulent may be referred to herein as a fraud risk model.

Data from past e-commerce transactions can be used to train a fraud risk model. There are several reasons why it is desirable for transaction data to be mature before it is used to train a fraud risk model. For example, when data is mature, enough time has passed since the transactions have occurred that accurate inferences can be drawn about whether or not the transactions are fraudulent. Another aspect of matured data is that there is a long enough time period of data in order to calculate aggregated data attributes for a model (e.g., fraud rates associated with a particular IP address or shipping address). In addition, useful key attributes from merchants are more likely to be available with matured data.

It can be beneficial for e-commerce merchants to join a consortium in which transaction data from a plurality of e-commerce merchants is used to create a fraud risk model. There are several potential benefits to such a consortium. For example, a consortium can make it possible to improve the accuracy and robustness of fraud risk models. Generally speaking, the more data that is used to train a machine learning model, the more accurate and robust the machine learning model is. Therefore, a consortium that uses data from a plurality of e-commerce merchants can create fraud risk models that are likely to be more accurate and robust than any fraud risk models that are created by any of the e-commerce merchants individually. Another potential benefit of a consortium is that it can enable at least some e-commerce merchants to have access to machine learning technology to which they would not otherwise have access. In addition, consortium members can learn new fraud patterns among each other and share common attribute histories. Furthermore, consortium members that do not have any historical data can still have their potential transactions be scored by a fraud risk model.

A fraud risk model that is used by a consortium can be developed based on all available data contributed by each consortium member. Ideally each consortium member should provide a significant amount (e.g., at least one year) of fully matured historical data for model training. This would allow the model to learn more complete data patterns from each member's historical data and provide the best risk prediction for each member. In reality, however, consortium members may join the consortium at different times, some members may provide less than the desired amount of historical data, and some consortium members may want to use the model without providing any historical data for model training. Currently known techniques fail to adequately address these differences in the maturity and quality of data provided by consortium members.

### SUMMARY

In accordance with one aspect of the present disclosure, a method is disclosed that includes receiving a request to evaluate a potential e-commerce transaction involving an e-commerce merchant. The method also includes selecting a fraud risk model to process transaction information associated with the potential e-commerce transaction. The fraud risk model is selected from among a plurality of possible fraud risk models that could be used to process the transaction information. The fraud risk model is selected based at least in part on quality and maturity of e-commerce merchant data provided by the e-commerce merchant. The e-commerce merchant data includes data related to transactions involving the e-commerce merchant. The method also includes processing the transaction information using the selected fraud risk model to generate a fraud risk indicator for the potential e-commerce transaction. The method also includes notifying a sender of the request about the fraud risk indicator.

The method may further include calibrating the fraud risk indicator for consistency among the plurality of possible fraud risk models.

The plurality of possible fraud risk models are designed for members of a consortium. The plurality of possible fraud risk models may include a starting fraud risk model that is designed for the members of the consortium who do not have any matured data. The plurality of possible fraud risk models may also include an intermediate fraud risk model that is designed for the members of the consortium who have less than a threshold time period of matured data. The plurality of possible fraud risk models may include a matured fraud risk model that is designed for the members of the consortium who have more than the threshold time period of matured data.

Selecting the fraud risk model may include determining that the e-commerce merchant data does not include any matured data and selecting a starting fraud risk model to process the transaction information.

Selecting the fraud risk model may include determining that the e-commerce merchant data includes some matured data but less than a threshold time period of the matured data and selecting an intermediate fraud risk model to process the transaction information.

Selecting the fraud risk model may include determining that the e-commerce merchant data includes more than a threshold time period of matured data and selecting a matured fraud risk model to process the transaction information.

The method may further include determining that the e-commerce merchant data satisfies a threshold quality level prior to generating the fraud risk indicator.

The method may further include providing configuration information associated with the e-commerce merchant. The configuration information may indicate the quality and the maturity of the e-commerce merchant data. The method may further include periodically updating the configuration information based on additional e-commerce merchant data received from the e-commerce merchant.

The method may further include determining that the e-commerce merchant data provided by the e-commerce merchant does not include any matured data and training a starting fraud risk model with the e-commerce merchant data provided by the e-commerce merchant.

The method may further include determining that the e-commerce merchant data provided by the e-commerce merchant includes some matured data but less than a threshold time period of the matured data. The method may further include training an intermediate fraud risk model with the e-commerce merchant data provided by the e-commerce merchant.

The method may further include determining that the e-commerce merchant data provided by the e-commerce merchant includes more than a threshold time period of matured data. The method may further include training a matured fraud risk model with the e-commerce merchant data provided by the e-commerce merchant.

The plurality of possible fraud risk models may include a matured fraud risk model. The matured fraud risk model may include a multi-layered model that accepts inputs from a plurality of other artificial intelligence models.

In accordance with another aspect of the present disclosure, a method is disclosed that includes obtaining configuration information associated with an e-commerce merchant. The configuration information indicates a quality level of e-commerce merchant data and an amount of matured data in the e-commerce merchant data. The e-commerce merchant data includes data related to transactions from the e-commerce merchant. The method further includes receiving a request to evaluate a potential e-commerce transaction involving an e-commerce merchant. The method further includes processing transaction information associated with the potential e-commerce transaction using a fraud risk model that is selected from among a plurality of possible fraud risk models based at least in part on the configuration information associated with the e-commerce merchant. The method further includes notifying a sender of the request about results from processing the transaction information.

The plurality of possible fraud risk models may be designed for members of a consortium. The plurality of possible fraud risk models include a starting fraud risk model that is designed for the members of the consortium who do not have any data or only have immature data. The plurality of possible fraud risk models also include an intermediate fraud risk model that is designed for the members of the consortium who have less than a threshold time period of matured data. The plurality of possible fraud risk models also include a matured fraud risk model that is designed for the members of the consortium who have more than the threshold time period of matured data.

The method may further include determining that the e-commerce merchant data does not include any matured data and selecting a starting fraud risk model to process the transaction information.

The method may further include determining that the e-commerce merchant data includes some matured data but less than a threshold time period of the matured data. The method may further include selecting an intermediate fraud risk model to process the transaction information.

The method may further include determining that the data provided by the e-commerce merchant includes more than a threshold time period of matured data and selecting a matured fraud risk model to process the transaction information.

The method may further include periodically updating the configuration information based on additional e-commerce merchant data received from the e-commerce merchant.

In accordance with another aspect of the present disclosure, a method is disclosed that includes obtaining e-commerce merchant data. The e-commerce merchant data includes data related to transactions from an e-commerce merchant. The method further includes processing a first set of potential e-commerce transactions from the e-commerce merchant using a first fraud risk model based at least in part on quality and maturity of the e-commerce merchant data at a first point in time. The method further includes processing a second set of potential e-commerce transactions from the e-commerce merchant using a second fraud risk model based at least in part on the quality and the maturity of the e-commerce merchant data at a second point in time. The method further includes notifying the e-commerce merchant about results of processing the first set of potential e-commerce transactions and the second set of potential e-commerce transactions.

The method further includes determining that the e-commerce merchant data does not include any matured data at the first point in time, processing the first set of potential e-commerce transactions using a starting fraud risk model, determining that the e-commerce merchant data includes at least some matured data at the second point in time, and processing the second set of potential e-commerce transactions using another fraud risk model other than the starting fraud risk model.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows. Features and advantages of the disclosure may be realized and obtained by means of the systems and methods that are particularly pointed out in the appended claims. Features of the present disclosure will become more fully apparent from the following description and appended claims, or may be learned by the practice of the disclosed subject matter as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. Understanding that the drawings depict some example embodiments, the embodiments will be described and explained with additional specificity and detail through the use of the accompanying drawings in which:

FIG. 1 illustrates an example showing transaction data being collected from a plurality of e-commerce merchants.

FIG. 2 illustrates an example showing how an e-commerce merchant can be associated with different fraud risk models as time progresses.

FIG. 3 illustrates an example of a system that is configured to calculate a risk score for a potential transaction involving an e-commerce merchant.

FIG. 4 illustrates an example of data processing that can occur with respect to an e-commerce merchant's data in the system shown in FIG. 3.

FIG. 5 illustrates an example of a system in which transaction data is classified into three categories (starting data, intermediate data, matured data) and used to develop three different types of fraud risk models (a starting model, an intermediate model, and a matured model).

FIG. 6 illustrates an example of a method that can be implemented by the data classification module in the system shown in FIG. 5.

FIG. 7 illustrates an example of a score calibration module.

FIG. 8 illustrates an example showing how the initial risk scores output by the various fraud risk models can be calibrated to the same score distribution.

FIG. 9 illustrates an example of a system in which a plurality of fraud risk models are used to determine whether a particular e-commerce transaction is likely to be fraudulent in production.

FIG. 10 illustrates an example of transaction data that can be provided by an e-commerce merchant and stored by a consortium.

FIG. 11 illustrates an example in which a matured fraud risk model can be a multi-layered model.

FIG. 12 illustrates certain components that can be included within a computing device.

### DETAILED DESCRIPTION

As noted above, e-commerce merchants can join a consortium in which transaction data from a plurality of e-commerce merchants is used to create a fraud risk model. However, there can be significant differences in the quality and maturity of data provided by different consortium members. For example, not all consortium members are able (or willing) to provide enough fully matured historical data for model training. If a fraud risk model is trained with a significant amount of fully matured historical data and then used by a consortium member without any (or much) historical data, this could lead to inaccurate assessments of the level of risk involved with potential e-commerce transactions.

To address this challenge, the present disclosure proposes developing and applying different fraud risk models for consortium members at different phases based on various factors, such as the maturity and quality of the transaction data that the consortium members provide. As an example, there can be three different fraud risk models corresponding to three different data phases: starting, intermediate, and matured. The starting model can be used for new consortium members who do not have matured data. The intermediate model can be used for the consortium members who have a relatively short time period of matured data (e.g., less than six months). The matured model can be used for the consortium members who have a relatively long time period of matured data (e.g., more than six months).

With this multi-phase modeling strategy, a consortium member can get its optimal model performance at different phases from an early phase where the consortium member does not have any historical data, to a more mature phase where the consortium member has a short time period of matured data, to a fully mature phase where the consortium member has a long-time period of matured data. In other words, a multi-phase modeling strategy as disclosed herein can improve the accuracy of the risk assessments that are produced. New members of the consortium can use a fraud risk model that does not rely on attributes associated with matured data. At the same time, the matured consortium data is not affected by the immature data from new members. Thus, the model performance for long-time existing members is not affected by new members at immature phases.

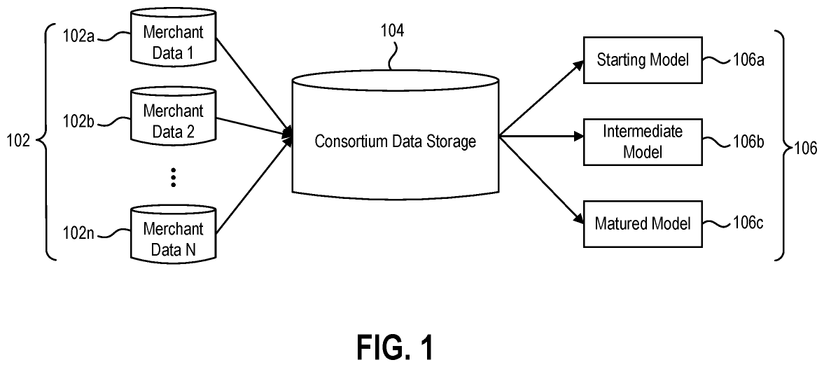

FIG. 1 illustrates an example showing transaction data 102 being collected from a plurality of e-commerce merchants and stored in consortium data storage 104. In particular, FIG. 1 shows transaction data 102a from a first e-commerce merchant, transaction data 102b from a second e-commerce merchant, and transaction data 102n from a Nth e-commerce merchant being collected and stored in consortium data storage 104. The transaction data 102 can be used to create a plurality of different fraud risk models 106. In the depicted example, the transaction data 102 is used to create a starting model 106a for new consortium members, an intermediate model 106b for consortium members who have a relatively short time period of matured data, and a matured model 106c for consortium members who have a relatively long time period of matured data.

For model training, the transaction data 102a-n from a plurality of merchants is collected into a consortium data storage 104, from which all the models 106a-c for different phases are developed. Various attributes can be calculated or otherwise determined for various transactions. In this context, the term “attribute” can refer to one or more characteristics of a particular transaction, such as whether the transaction was fraudulent, the types of goods or services that were purchased during the transaction, the payment information that was used to complete the transaction, the email address that was used to complete the transaction, the IP address of the computing device that was used to complete the transaction, and so forth. The attributes that are determined for a particular transaction can also include a summary of previous transactions made by the same user. Such summary information can include the number of transactions made by the same user in any given time window and/or the last purchase information from the same user, the same IP address, the same payment instrument, and so forth.

The specific number of fraud risk models 106 shown in FIG. 1 is for purposes of example only, and should not be interpreted as limiting the scope of the present disclosure. A different number of fraud risk models 106 can be developed and used in accordance with the present disclosure.

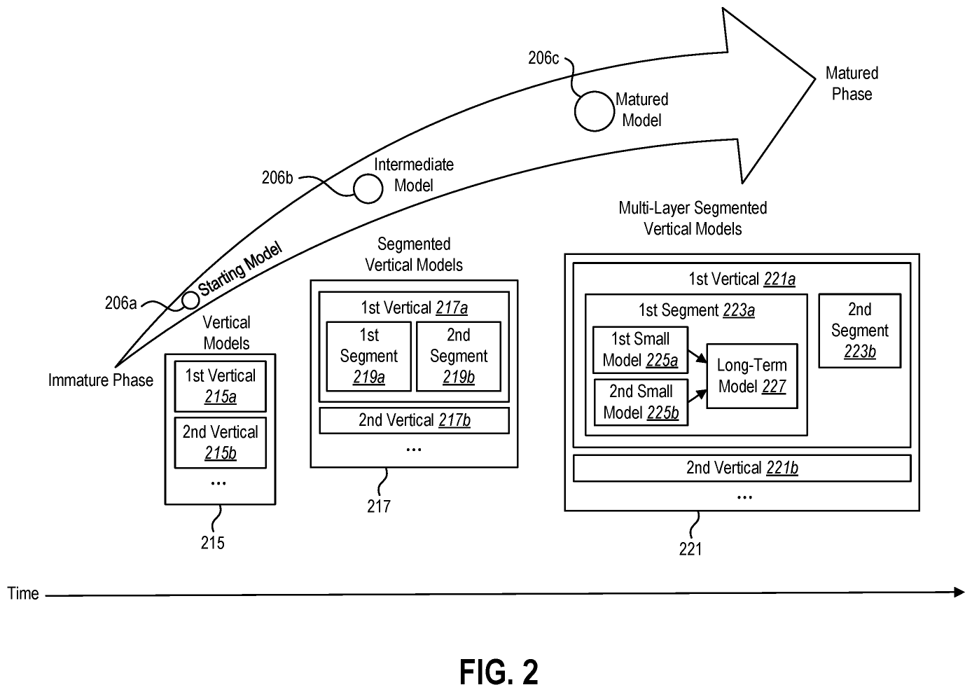

FIG. 2 illustrates an example showing how an e-commerce merchant can be associated with different fraud risk models as time progresses. In the depicted example, there are three fraud risk models: a starting model 206a, an intermediate model 206b, and a matured model 206c. The starting model 206a is designed for members of the consortium who do not have any historical data, or who have some historical data that is not yet matured. The intermediate model 206b is designed for members of the consortium with a short time period (e.g., less than six months) of matured data. The matured model 206c is designed for members of the consortium with a long time period (e.g., more than six months) of matured data.

When an e-commerce merchant joins the consortium, the e-commerce merchant can initially be assigned to the starting model 206a. In other words, transactions from that e-commerce merchant can be processed using the starting model 206a. Also, transaction data provided by the e-commerce merchant can be used to train the starting model 206a.

When at least some of the data from the e-commerce merchant has matured, the e-commerce merchant can be switched from the starting model 206a to the intermediate model 206b. Transactions from that e-commerce merchant can then be processed using the intermediate model 206b. Also, transaction data provided by the e-commerce merchant can be used to train the intermediate model 206b and the starting model 206a.

When a long time period (e.g., six months or more) of matured data has been collected from the e-commerce merchant, the e-commerce merchant can be switched from the intermediate model 206b to the matured model 206c. Transactions from that e-commerce merchant can then be processed using the matured model 206c. Also, transaction data provided by the e-commerce merchant can be used to train all of the fraud risk models 206a-c.

In some embodiments, at least two flags can be associated with each consortium member: a first flag that indicates whether or not a member's data has matured, and a second flag that indicates how many days the data has been matured. The first flag may be referred to herein as an IsDataMature flag. The second flag may be referred to herein as a DataMatureDays flag. If the IsDataMature flag is set to true for a particular consortium member, this means that the consortium member has provided data over a long enough time period of data in order to calculate aggregated data attributes for a model and also that the data have enough good/bad labels. (In this context, the term “label” can refer to an indication about whether a transaction was fraudulent or not.) In some embodiments, the IsDataMature flag is set to true for a particular e-commerce merchant if the data provided by that e-commerce merchant is older than a threshold time period. The DataMatureDays flag can indicate how long (e.g., how many days) the data has been matured.

In some embodiments, if the value of the IsDataMature flag for a particular consortium member is false, then that consortium member is assigned to the starting model 206a. If the value of the IsDataMature flag for a particular consortium member is true and the DataMatureDays flag is less than or equal to a pre-defined time period (e.g., less than or equal to 180 days), then that consortium member is assigned to the intermediate model 206b. If the value of the IsDataMature flag for a particular consortium member is true and the DataMatureDays flag is greater than the pre-defined time period (e.g., greater than 180 days), then that consortium member is assigned to the matured model 206c.

As shown in FIG. 2, a particular fraud risk model can include a plurality of vertical models 215, including a first vertical model 215a, a second vertical model 215b, and so forth. The vertical models 215 can be designed for different business “verticals,” i.e., companies that offer specific product(s) or service(s) to a specific customer base rather than offering a wide range of products or services in a wider market. A few examples of business verticals include gaming, online ticketing, and retail.

In embodiments where a fraud risk model includes a plurality of vertical models 215, e-commerce merchants can be matched to the vertical model 215 that corresponds most closely to the e-commerce merchant's type of business. For example, suppose that the first vertical model 215a corresponds to gaming and the second vertical model 215b corresponds to online ticketing. In this example, the first vertical model 215a could be applied to data from a gaming merchant, while the second vertical model 215b could be applied to data from an online ticketing merchant.

As also shown in FIG. 2, a particular fraud risk model can include a plurality of segmented vertical models 217. In this context, a segmented vertical model 217 can be a vertical model that has been divided into a plurality of segments. In this context, a segment can refer to a logical division within a business vertical. For example, within the business vertical of gaming, at least two segments can be created: web-based gaming and console-based gaming. The segmented vertical models 217 shown in FIG. 2 include a first vertical model 217a and a second vertical model 217b. The first vertical model 217a includes a first segment 219a and a second segment 219b. The second vertical model 217b can also include a plurality of segments, although this is not shown in FIG. 2.

In embodiments where a fraud risk model includes a plurality of segmented vertical models 217, e-commerce merchants can be matched to the particular segment that corresponds most closely to the e-commerce merchant's type of business. For example, suppose that the first segment 219a of the first vertical model 217a corresponds to web-based gaming, and the second segment 219b of the first vertical model 217a corresponds to console-based gaming. In this example, the first segment 219a of the first vertical model 217a could be applied to data from a gaming merchant who specializes in web-based gaming, while the second segment 219b of the first vertical model 217a could be applied to data from a gaming merchant who specializes in console-based gaming.

As also shown in FIG. 2, a particular fraud risk model can include a plurality of multi-layer segmented vertical models 221. In this context, a multi-layer segmented vertical model 221 can be a segmented vertical model that has been further subdivided. For example, the multi-layer segmented vertical models 221 shown in FIG. 2 include a first vertical model 221a and a second vertical model 221b. The first vertical model 221a includes a first segment 223a and a second segment 223b. The first segment 223a is shown with a first small model 225a and a second small model 225b, which are provided as input to a long-term model 227.

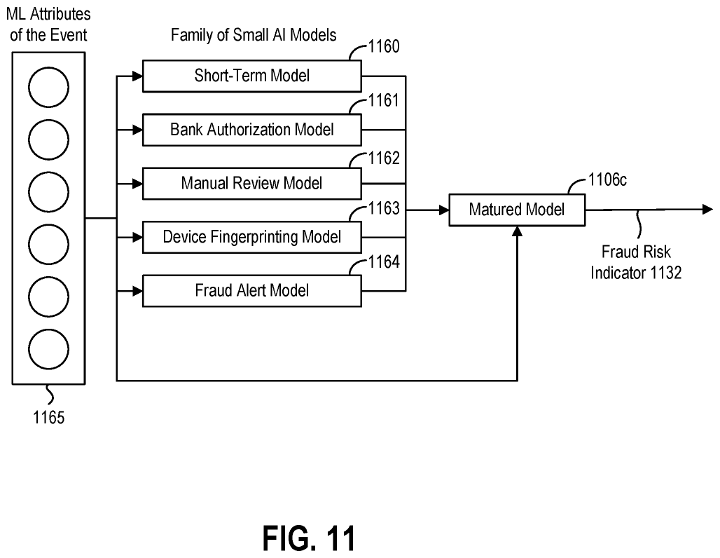

In some embodiments, the small models 225a-b can be trained based on the subpopulations of transactions or partial/fuzzy fraud labels. Risk scores generated by the small models 225a-b can be used as data attributes for the long-term model 227, which can further improve the performance of the long-term model 227. A more specific example of a multi-layer model will be discussed below in connection with FIG. 11.

Although not shown in FIG. 2 for the sake of simplicity, the second segment 223b can be configured similarly to the first segment 223a, and the second vertical model 221b can be configured similarly to the first vertical model 221a.

In some embodiments, the fraud risk model that is used in connection with a particular e-commerce merchant can increase in complexity as the maturity of the merchant's data increases. For example, a starting model 206a can include a plurality of vertical models 215. An intermediate model 206b can include a plurality of segmented vertical models 217. A matured model 206c can include a plurality of multi-layer segmented vertical models 221.

As noted previously, a fraud risk model can be used to evaluate the risk associated with a proposed e-commerce transaction. In some embodiments, a fraud risk model can produce a risk score for the proposed transaction. The risk score can indicate the likelihood (or probability) that the proposed transaction is fraudulent. In some embodiments, a risk score can alternatively be referred to as a probability score.

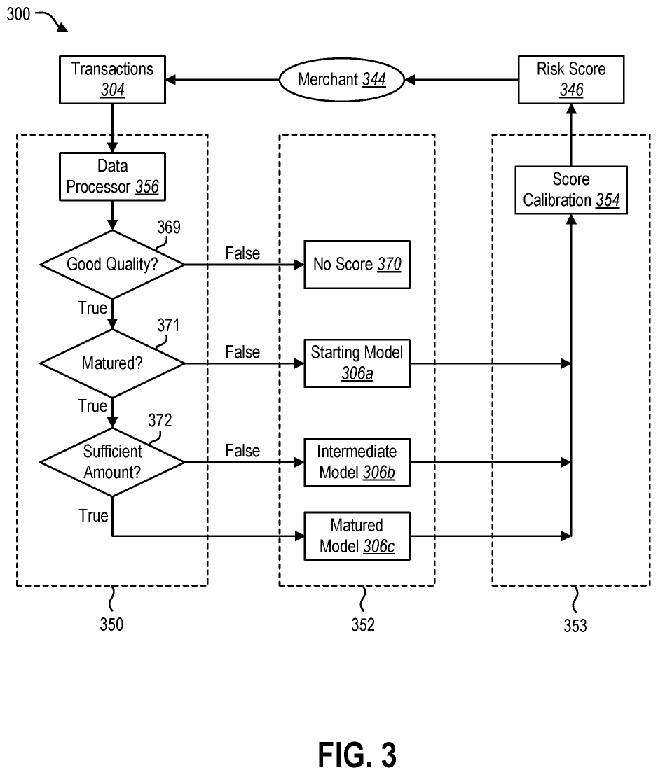

FIG. 3 illustrates an example of a system 300 that is configured to calculate a risk score 346 for a potential transaction 304 involving an e-commerce merchant. The present disclosure proposes applying different fraud risk models for e-commerce merchants at different phases. Thus, the system 300 can be configured to use one of a plurality of fraud risk models (e.g., a starting model 306a, an intermediate model 306b, or a matured model 306c) to determine the risk score 346. The system 300 can dynamically and automatically choose the proper model for scoring based on the merchant data maturity and data quality. The system 300 includes three sections: a data processing section 350, a model scoring section 352, and a score calibration section 353.

The data processing section 350 includes a data processor 356, which can be configured to perform periodic (e.g., daily, weekly) statistical calculations on a number of data attributes. These calculations can be used to determine data maturity and data quality. The data processor 356 can tag the incoming transactions 304 with the IsDataMature and DataMatureDays flags described above. The data processor 356 can also be configured to determine the value of the IsDataMature flag and to determine the value of the DataMatureDays flag for incoming transactions 304.

As indicated above, the model scoring section 352 includes three phases of models: a starting model 306a, an intermediate model 306b, and a matured model 306c. The model inputs and model design are all specific for the particular phase of data. An incoming transaction can be scored by one of the phase models based on the IsDataMature and DataMatureDays flags associated with the transaction.

When a potential transaction 304 is received from an e-commerce merchant 344, the data processor 356 can determine 369 whether the data that is available for that e-commerce merchant 344 (i.e., the data that has previously been received from the e-commerce merchant 344) is good quality data. Data can be considered to be of good quality if the data includes labels indicating whether or not transactions are fraudulent and if the data includes various attributes related to the transactions. Some examples describing how the quality of the data can be evaluated will be described below. In some embodiments, the data processor 356 can determine 369 whether the quality of the data that has been received from that e-commerce merchant 344 exceeds a pre-defined threshold. If not, then a risk score 346 is not generated for that transaction 304. FIG. 3 shows a result of no score 370 when it is determined 369 that the available data for that e-commerce merchant 344 is not good quality data.

If the data processor 356 determines 369 that the data that has been received from the e-commerce merchant 344 is good quality data, the data processor 356 can also determine 371 whether the data that has been received from the e-commerce merchant 344 has matured. In some embodiments, this involves determining whether the value of the IsDataMature flag for a particular transaction 304 is true or false. If it is determined 371 that the data that has been received from the e-commerce merchant 344 has not matured (e.g., if it is determined that the value of the IsDataMature flag is false), then that transaction 304 is scored by the starting model 306a.

If the data processor 356 determines 371 that the data that has been received from the e-commerce merchant 344 has matured, the data processor 356 can also determine 372 whether the merchant 344 has a sufficient amount of matured data. For example, the data processor 356 can determine whether the amount of matured data from the merchant 344 exceeds a pre-defined threshold. In some embodiments, this involves determining whether the value of the DataMatureDays flag is less than or equal to a pre-defined value (e.g., less than or equal to 180 days).

If the data processor 356 determines 372 that the merchant 344 does not have a sufficient amount of matured data, then the transaction 304 is scored by the intermediate model 306b. If, however, the data processor 356 determines 372 that the e-commerce merchant 344 has a sufficient amount of matured data, then the transaction 304 is scored by the matured model 306c.

For example, in some embodiments, if it is determined that the value of the IsDataMature flag for a particular transaction 304 is false, then that transaction 304 is scored by the starting model 306a. If it is determined that the value of the IsDataMature flag for a particular transaction 304 is true and it is determined that the value of the DataMatureDays flag is less than or equal to a pre-defined value (e.g., less than or equal to 180 days), then that transaction 304 is scored by the intermediate model 306b. If it is determined that the value of the IsDataMature flag for a particular transaction 304 is true and it is determined that the value of the DataMatureDays flag is greater than the pre-defined value (e.g., greater than 180 days), then that transaction 304 is scored by the matured model 306c.

With currently known approaches, the same fraud risk model is used for different e-commerce merchants whose are at different phases and whose data possesses different levels of quality and maturity. In contrast, the system 300 shown in FIG. 3 includes different fraud risk models 306a-c for different phases, and the best fraud risk model for a particular e-commerce merchant can be chosen based on the quality and maturity of that merchant's data.

In some embodiments, different transactions 304 from the same merchant can be scored by different fraud risk models based on data maturity and data quality. For example, some transactions from a particular merchant can be scored by the starting model 306a, other transactions from that same merchant can be scored by the intermediate model 306b, and other transactions from that same merchant can be scored by the matured model 306c.

Score distributions can be quite different for fraud risk models corresponding to different phases. For example, the score distribution for the starting model 306a can differ from the score distribution for the intermediate model 306b, which can also differ from the score distribution for the matured model 306c. The score calibration module 354 can be used to ensure that each merchant can always observe a stable and consistent score distribution.

More specifically, whichever one of the fraud risk models 306a-c is selected to score a particular transaction 304 can output an initial risk score. This initial risk score can be adjusted by the score calibration module 354 to generate a final risk score 346. The adjustments made by the score calibration module 354 can ensure that each merchant 344 observes a stable and consistent score distribution. Some examples of how calibration can be performed will be described below.

In some embodiments, the fraud risk models 306a-c are only trained based on similar quality data. In this way, the consortium members with good quality data will not be impacted by the members with poor quality data. Each consortium member can always get the optimal model performance for each data phase based on its data maturity and data quality. As the quality and maturity of data from a particular consortium member improves, the consortium member can get improved performance from the system 300. For example, when an e-commerce merchant initially joins the consortium, the starting model 306a can be used to score the transactions from that e-commerce merchant because the e-commerce merchant does not have any matured data. Once the data provided by the e-commerce merchant has matured, however, the intermediate model 306b or the matured model 306c can be used to score the transactions from the e-commerce merchant depending on how long the data has been matured.

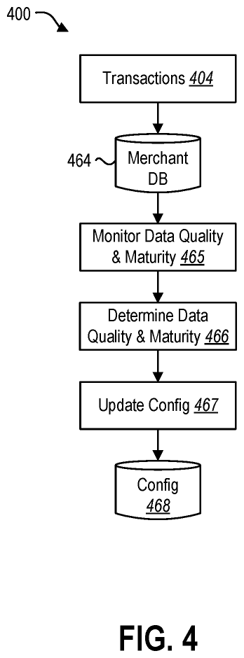

FIG. 4 illustrates additional data processing that can occur with respect to an e-commerce merchant's data. In some embodiments, the data processing shown in FIG. 4 can be implemented in a system that calculates risk scores for potential transactions, such as the system 300 shown in FIG. 3. The data processing that is shown in FIG. 4 can be useful for determining whether the data that has been received from an e-commerce merchant is good quality data, whether the data that has been received from the e-commerce merchant has matured, and whether the merchant has a sufficient amount of matured data.

When a transaction 404 involving a particular e-commerce merchant is received, a data processor (e.g., the data processor 356 in the system 300 shown in FIG. 3) can determine attributes associated with that transaction 404. Data about the transaction 404 and its attributes can be stored in a database 464. This database 464 may be referred to herein as an e-commerce merchant database 464. Over time, the e-commerce merchant database 464 can grow to include data about a large number of transactions 404 involving the e-commerce merchant. The quality and maturity of the data can be periodically checked. Depending at least in part on the result of these checks for quality and maturity, one of a plurality of fraud risk models (such as the fraud risk models 306a-c in the system 300 shown in FIG. 3) can be selected to score new transactions 404 from the e-commerce merchant.

More specifically, data related to transactions 404 from a particular e-commerce merchant can be stored in the e-commerce merchant database 464. This data can be monitored 465, and the quality and maturity of the merchant data 464 can be determined 466. Configuration information 468 about the e-commerce merchant can be updated 467 based on the quality and maturity of the data that has been provided by the e-commerce merchant. The selection of one of the available fraud risk models to generate a risk score for a particular transaction 404 involving the e-commerce merchant can be based at least in part on the configuration information 468 that has been determined for the e-commerce merchant.

As indicated previously, the fraud risk model that is used to score transactions involving a particular e-commerce merchant can change over time. Switching among a plurality of different fraud risk models (e.g., the fraud risk models 306a-c in the system 300 shown in FIG. 3) can be done dynamically and automatically based on the maturity of the data that is received from an e-commerce merchant. As the data that is received from the e-commerce merchant becomes more mature, the fraud risk model that is used to score transactions involving the e-commerce merchant can be automatically changed (e.g., from the starting model 306a, to the intermediate model 306b, to the matured model 306c). During periods of time when the data that is received from the e-commerce merchant is of poor quality (e.g., no labels, missing periods of transactions), the transactions involving the e-commerce merchant can be automatically scored by models that are better suited to handling less mature data (e.g., the intermediate model 306b or the starting model 306a).

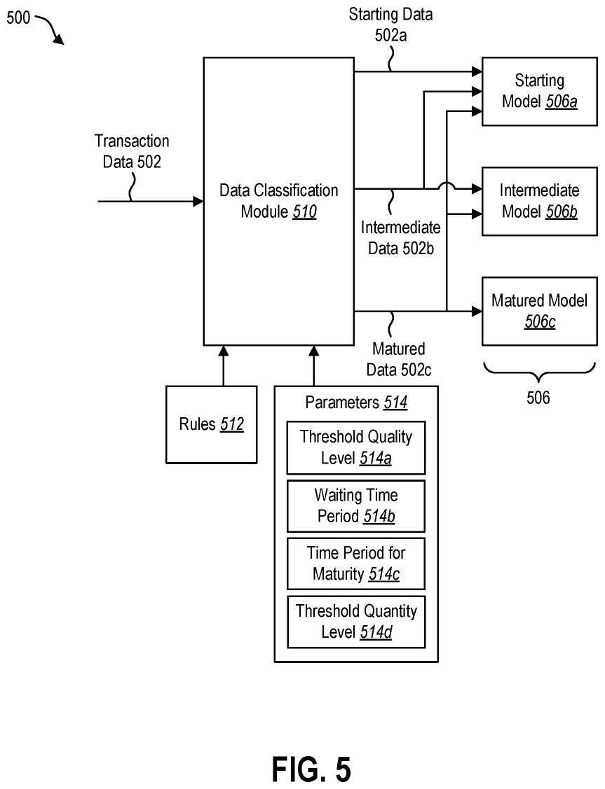

FIG. 5 illustrates an example of a system 500 in which transaction data 502 is classified into three categories (starting data 502a, intermediate data 502b, matured data 502c) and used to develop three different types of fraud risk models 506: a starting model 506a, an intermediate model 506b, and a matured model 506c. For training purposes, different categories can be defined for the transaction data 502 that is collected from e-commerce merchants. The different categories can correspond to the different types of fraud risk models 506. In particular, there can be a category corresponding to the starting model 506a, a category corresponding to the intermediate model 506b, and a category corresponding to the matured model 506c. The category corresponding to the starting model 506a can be referred to as a starting data category. The category corresponding to the intermediate model 506b can be referred to as an intermediate data category. The category corresponding to the matured model 506c can be referred to as a matured data category.

For training purposes, transaction data 502 that is received from e-commerce merchants can be classified into one of the different categories based at least in part on the maturity and/or the quality of the transaction data 502. The system 500 shown in FIG. 5 includes a data classification module 510 that is configured to perform this classification. Transaction data 502 that is classified in the starting data category can be referred to as starting data 502a. Transaction data 502 that is classified in the intermediate data category can be referred to as intermediate data 502b. Transaction data 502 that is classified in the matured data category can be referred to as matured data 502c.

Rules 512 can be defined that indicate which transaction data 502 can be used for training the different types of fraud risk models 506 that are being developed and used. In some embodiments, the rules 512 can indicate that (i) starting data 502a should only be used to train the starting model 506a, (ii) intermediate data 502b can be used to train the intermediate model 506b and the starting model 506a, but not the matured model 506c, and (iii) matured data 502c can be used to train all of the models 506a-c.

Various parameters 514 can also be defined. These parameters 514 can be used in connection with classifying transaction data 502 into the various categories. In the depicted example, the parameters include a threshold quality level 514a, a time period 514b, and a threshold quantity level 514c. These parameters 514a, 514b, 514c will be discussed in greater detail below.

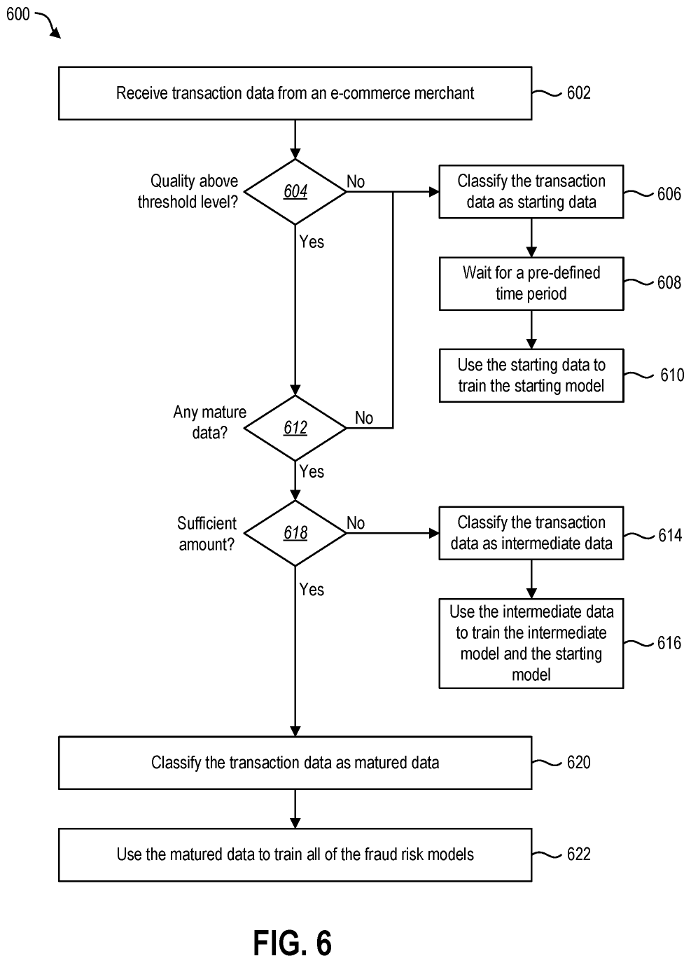

FIG. 6 illustrates an example of a method 600 that can be implemented by the data classification module 510 in the system 500 shown in FIG. 5 in order to classify the transaction data 502 that is received from a particular e-commerce merchant for purposes of training one or more fraud risk models 506.

In accordance with the method 600, transaction data 502 can be received 602 from an e-commerce merchant. The data classification module 510 can then determine 604 whether the quality of the transaction data 502 exceeds a pre-defined threshold quality level 514a. The quality of the transaction data 502 can be based at least partially on whether the transaction data 502 identifies whether the transactions are fraudulent or not. The quality of the transaction data 502 can also be based at least partially on how much other information is included in the transaction data 502. In some embodiments, a set of fields can be defined (e.g., by the consortium) for the transaction data 502. This set of fields can represent the information that should ideally be included in the transaction data 502. The quality of the transaction data 502 can be measured in terms of how many of those fields include non-null values.

In some embodiments, several other criteria can be employed to ensure the data quality is good enough for model training. As an example, a basis point can be determined, i.e., the number of chargeback transactions over the overall transactions multiplied by 10,000. In addition, the weight of evidence (WoE) can be determined. The WoE represents a normalized fraud rate per attribute values in one attribute. In addition, the information value (IV) can be determined. The IV represents a weighted sum of WoE, using the difference between the normalized fraud rate and the overall fraud rate as weight, per attribute.

If the quality of the transaction data 502 does not exceed the pre-defined threshold quality level 514a, then the transaction data 502 can be classified 606 as starting data 502a. With starting data 502a, it may be desirable to wait 608 for a pre-defined time period 514b before using 610 the starting data 502a to train the starting model 506a.

If the data classification module 510 determines 604 that the quality of the transaction data 502 exceeds the pre-defined threshold quality level 514a, the data classification module 510 can also determine 612 whether the transaction data 502 includes any matured data. In some embodiments, transaction data 502 corresponding to a set of transactions can be said to be “mature” if enough time has passed since the transactions have occurred that accurate inferences can be drawn about whether or not the transactions are fraudulent. In some embodiments, a time period 514c can be defined for matured data. If a particular set of transaction data 502 includes at least some transactions where the difference between the current date and the date that the transaction occurred exceeds the defined time period 514c, then the transaction data 502 can be considered to include at least some matured data.

If the data classification module 510 determines 612 that the transaction data 502 does not include any matured data, then the transaction data 502 can be classified 606 as starting data 502a, and the method 600 can proceed as described above. If, however, the data classification module 510 determines 612 that the transaction data 502 includes at least some matured data, then the data classification module 510 can also determine 618 whether the amount of matured transaction data 502 exceeds the pre-defined quantity level 514d. If it does not, then the transaction data 502 can be classified 614 as intermediate data 502b and used 616 to train the intermediate model 506b and the starting model 506a. On the other hand, if the data classification module 510 determines 618 that the amount of matured transaction data 502 exceeds the pre-defined quantity level 514d, then the transaction data 502 can be classified 620 as matured data 502c and used 622 to train all of the fraud risk models 506a-c.

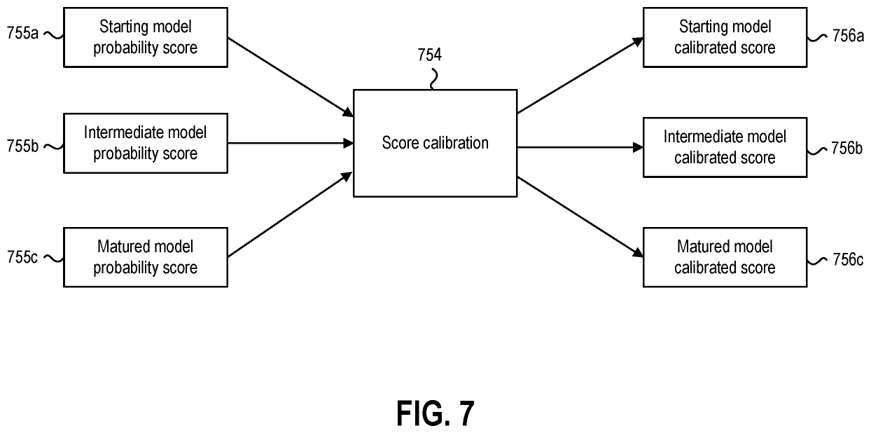

FIG. 7 illustrates an example of a score calibration module 754. The score calibration module 754 is an example of the score calibration modules 354, 754 in the systems 300, 400 described above. As indicated previously, the score calibration module 754 is configured to adjust an initial risk score that is output by a particular fraud risk model to determine a model calibrated risk score. In some embodiments, the initial risk score can be calibrated based on the fraud rate for each score bin for the given model development data set. The initial risk score can represent the fraud probability, and therefore it may be referred to as a probability score. FIG. 7 shows an initial risk score 755a determined by a starting model, an initial risk score 755b determined by an intermediate model, and an initial risk score 755c determined by a matured model. The score calibration module 754 is configured to adjust the starting model initial risk score 755a to produce a starting model calibrated risk score 756a, adjust the intermediate model initial risk score 755b to produce an intermediate model calibrated risk score 756b, and adjust the matured model initial risk score 755c to produce a matured model calibrated risk score 756c.

The initial risk scores 755a-c output by the various fraud risk models can have different score distributions. However, it is desirable for the risk score that is ultimately presented to an e-commerce merchant to have a stable score distribution. In other words, if a risk score of N is presented to the e-commerce merchant, it is desirable for this risk score to indicate the same level of risk regardless of whether it was calculated by the starting fraud risk model, the intermediate fraud risk model, or the matured risk model.

In some embodiments, the initial risk scores 755a-c output by the various fraud risk models can be calibrated to an expected score distribution, which can be from a specific model or predefined by a merchant.

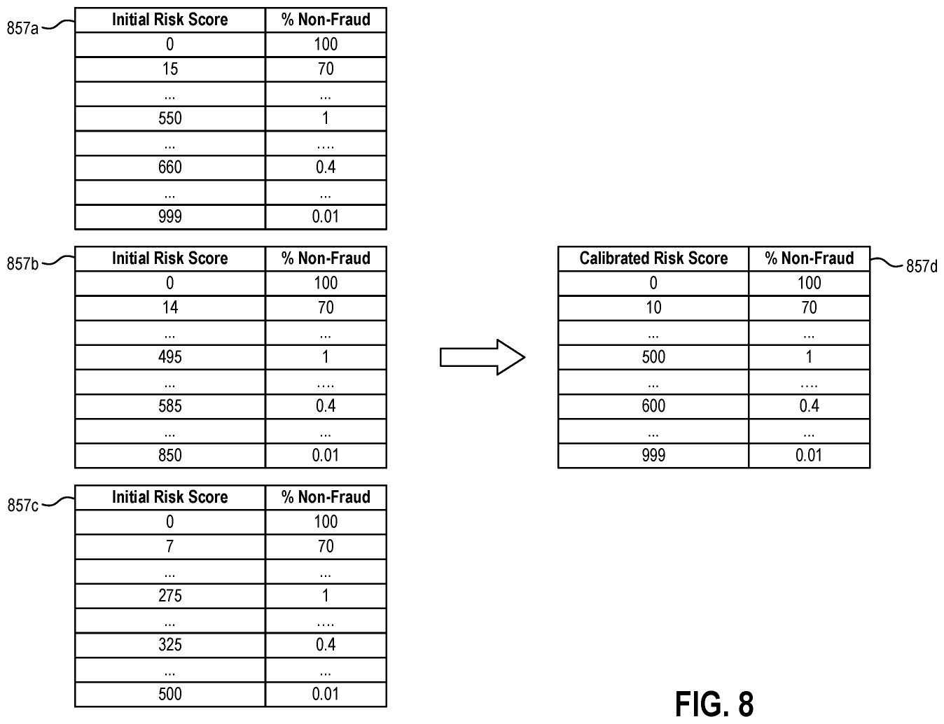

FIG. 8 illustrates an example showing how a set of initial risk scores (e.g., the initial risk scores 755a-c shown in FIG. 7) output by various fraud risk models can be calibrated to an expected score distribution. In some embodiments, the score distribution is dominated by non-fraudulent transactions. Thus, the model score calibration can be based on a non-fraudulent score distribution.

In the depicted example, four tables 857a-d are utilized. The three tables 857a-c on the left show the initial non-fraud score distribution from various fraud risk models. More specifically, the upper table 857a shows the initial non-fraud score distribution from a starting fraud risk model (e.g., the starting fraud risk model 306a in the system 300 of FIG. 3), the middle table 857b shows the initial non-fraud score distribution from an intermediate fraud risk model (e.g., the intermediate fraud risk model 306b in the system 300 of FIG. 3), and the lower table 857c shows the initial non-fraud distribution from a matured fraud risk model (e.g., the matured fraud risk model 306c in the system 300 of FIG. 3). These tables 857a-c may be referred to herein as initial non-fraud score distribution tables 857a-c. The table 857d on the right shows the desired or expected risk score distribution for a particular e-commerce merchant or from a specific model. This table 857d may be referred to herein as a model calibrated risk score distribution table 857d.

In the initial risk score distribution tables 857a-c, each of the tables represents the non-fraud score distribution from a specific fraud risk model. The score distributions from the three models are different. For instance, in the preliminary risk score distribution table 857a for the starting fraud risk model, 70% non-fraud transactions were scored as greater or equal to 15. In the initial risk score distribution table 857b for the intermediate fraud risk model, the same percentage of non-fraud transactions were scored as greater or equal to 14. In the initial risk score distribution table 857c for the matured fraud risk model, the same percentage of non-fraud transactions were scored as greater or equal to 7.

The calibrated risk score distribution table 857d represents the expected non-fraud score distribution that should be presented to the e-commerce merchant. A score calibration module (e.g., either of the score calibration modules 354, 754 described previously) can use the calibrated risk score distribution table 857d to determine the calibrated risk score that is presented to an e-commerce merchant.

For instance, if a starting fraud risk model outputs an initial risk score of 15, a score calibration module can access the initial risk score distribution table 857a for the starting fraud risk model to determine that the initial risk score of 15 corresponds to 70% non-fraud transactions. The score calibration module can then access the calibrated risk score distribution table 857d to determine that corresponding to this percentage (i.e., 70% non-fraud transactions) the calibrated risk score of 10 should be presented to the e-commerce merchant.

Similarly, if an intermediate fraud risk model outputs an initial risk score of 14, the score calibration module can access the initial risk score distribution table 857b for the intermediate fraud risk model to determine that the initial risk score of 14 corresponds to 70% non-fraud transactions. The score calibration module can then access the calibrated risk score distribution table 857d to determine that corresponding to this percentage the calibrated risk score of 10 should be presented to the e-commerce merchant.

Also, if a matured fraud risk model outputs an initial risk score of 7, the score calibration module can access the initial risk score distribution table 857c for the matured fraud risk model to determine that the initial risk score of 7 corresponds to 70% non-fraud transactions. The score calibration module can then access the calibrated risk score distribution table 857d to determine that corresponding to this percentage the calibrated risk score of 10 should be presented to the e-commerce merchant. Therefore, even though the various fraud risk models output different initial risk score distributions for the same merchant, the same model calibrated risk score distribution can be presented to the e-commerce merchant.

In some embodiments, a calibrated risk score distribution table like the calibrated risk score distribution table 857d shown in FIG. 8 can be predefined for each of a plurality of e-commerce merchants. A particular e-commerce merchant can choose its expected score distribution for the calibrated risk scores.

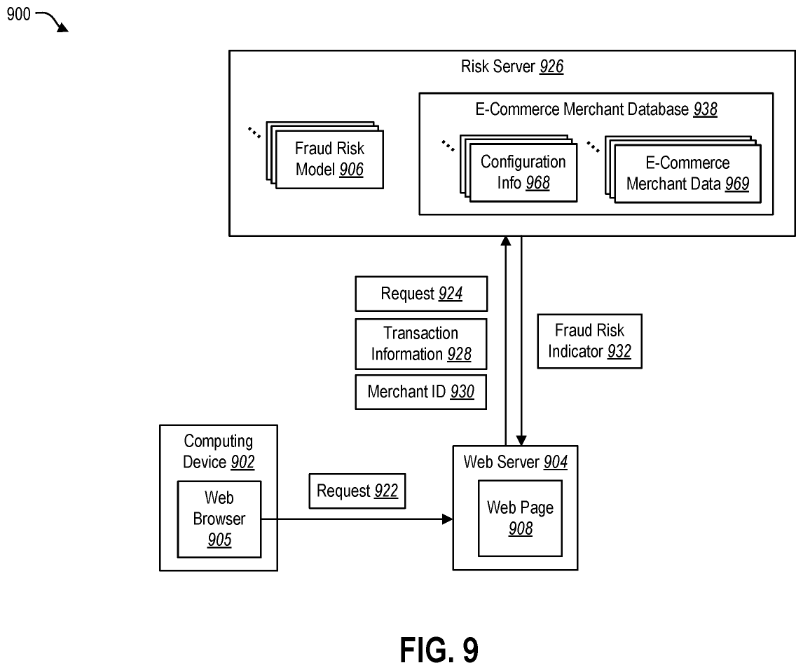

FIG. 9 illustrates an example of a system 900 in which a plurality of fraud risk models 906 are used to determine whether a particular e-commerce transaction is likely to be fraudulent in production. The system 900 includes a computing device 902 in electronic communication with a web server 904 via the Internet. The web server 904 can be maintained by an e-commerce merchant. The e-commerce merchant can belong to a consortium in which transaction data from a plurality of e-commerce merchants is used to create the fraud risk models 906. The risk server 926 can be maintained by or associated with the consortium. When the user of the computing device 902 navigates the web browser 905 to a uniform resource locator (URL) corresponding to a web page 908 that is maintained by the web server 904, the web server 904 sends the web page 908 to the web browser 905.

At some point, there may be an event for which authorization from a risk server 926 should be obtained. For example, the user of the computing device 902 may want to perform a transaction on the web page 908, such as making a purchase. The user may provide some type of input to the computing device 902 to initiate the transaction. In response to this user input, the web browser 905 can send a request 922 to the web server 904 for the transaction to occur.

In response to receiving this request 922 from the web browser 905, the web server 904 can send a request 924 to a risk server 926 for authorization to proceed with the transaction. The web server 904 can also send certain information 928 associated with the transaction to the risk server 926. This information 928, which may be referred to herein as transaction information 928, can be used by the risk server 926 to determine whether or not the transaction should be authorized. The transaction information 928 can include any of the attributes of a transaction that were described above (e.g., the types of goods or services that are being purchased, the payment information provided by the user of the computing device 902 in connection with the transaction, the email address provided by the user of the computing device 902 in connection with the transaction, the IP address of the computing device 902). In addition, the web server 904 can also send a merchant ID 930 to the risk server 926.

The risk server 926 can process the transaction information 928 using one of a plurality of fraud risk models 906 to produce a fraud risk indicator 932 regarding the transaction. The fraud risk indicator 932 can include a risk score, such as the risk score 346 described previously. In some embodiments, the fraud risk indicator 932 can include a decision about the potential transaction (e.g., authorized or not authorized).

The risk server 926 can determine which of the plurality of fraud risk models 906 should be used based at least in part on the merchant ID 930. For example, the risk server 926 can maintain an e-commerce merchant database 938 that includes information about the e-commerce merchants that have joined the consortium. The information that is associated with a particular e-commerce merchant can include configuration information 968 and e-commerce merchant data 969. The configuration information 968 can be similar to the configuration information 468 described previously in connection with the system 400 of FIG. 4. The risk server 926 can use the merchant ID 930 to identify the configuration information 968 that is associated with the merchant who sent the request 924. The configuration information 968 can be used to determine which fraud risk model 906 should be used to process the transaction information 928.

The risk server 926 sends the fraud risk indicator 932 back to the sender of the request 924, which in this case is the web server 904. The web server 904 makes a decision about whether or not to proceed with the transaction based at least in part on the fraud risk indicator 932. In embodiments where the fraud risk indicator 932 is a risk score, the web server 904 can decide whether to proceed with the transaction by comparing the risk score to a threshold value. In embodiments where higher risk scores correspond to higher levels of risk, then the web server 904 can proceed with the transaction as long as the risk score is below the defined threshold value. Alternatively, in embodiments where lower risk scores correspond to higher levels of risk, then the web server 904 can proceed with the transaction as long as the risk score is above the defined threshold value.

In embodiments where the fraud risk indicator 932 is a decision about whether to proceed with the transaction (e.g., authorized or not authorized), the web server 904 can determine whether to proceed with the transaction based on this decision. For example, if the fraud risk indicator 932 indicates that the transaction is less likely fraudulent, then the web server 904 can decide to proceed with the transaction. If, however, the fraud risk indicator 932 indicates that the transaction is more likely fraudulent, then the web server 904 can decide to not proceed with the transaction.

With current approaches, the same fraud risk model 906 is used for all e-commerce merchants. If the fraud risk model 906 relies on attributes associated with fully matured data, this can decrease the accuracy of the fraud risk indicators 932 that are generated for e-commerce merchants that do not have matured data. On the other hand, if the fraud risk model 906 does not rely on attributes associated with matured data, this can decrease the accuracy of the fraud risk indicators 932 that are generated for e-commerce merchants that have a significant amount of fully matured historical data.

Having a plurality of fraud risk models 906 instead of just a single fraud risk model can improve the accuracy of the fraud risk indicators 932 that are generated, which can reduce the incidence of fraud that occurs in e-commerce transactions. For an e-commerce merchant that does not have any (or much) historical data, a fraud risk model 906 can be used that does not rely on attributes associated with matured data (e.g., aggregated attributes, such as the fraud rate associated with a particular characteristic such as IP address or shipping address). On the other hand, for an e-commerce merchant that has a significant amount of fully matured historical data, a fraud risk model 906 can be used that uses these attributes.

To achieve optimal performance, it may not be desirable for all of the transaction data that is collected from e-commerce merchants to be used for training each type of fraud risk model. For example, it may not be desirable for transaction data from new consortium members whose data is not mature to be used for training a fraud risk model that is designed for consortium members whose data is mature. In accordance with the present disclosure, the transaction data that is used for training a particular type of fraud risk model can be selected based on certain characteristics of the transaction data, such as the maturity and quality of the transaction data.

In some embodiments, the transaction data that is collected from the e-commerce merchants in the consortium can be classified into different categories. The categories can correspond to the types of fraud risk models that are being developed and used. Rules can then be defined that indicate which transaction data can be used for training the different types of fraud risk models that are being developed and used.

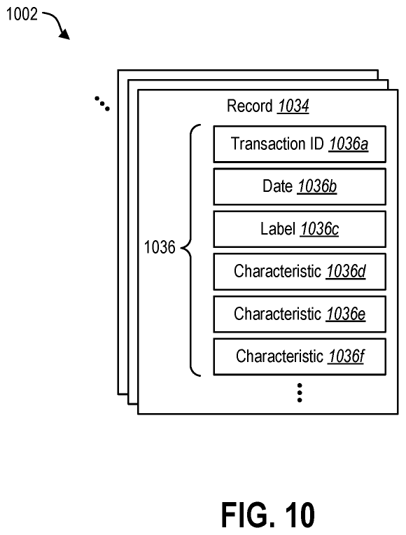

FIG. 10 illustrates an example of transaction data 1002 that can be provided by an e-commerce merchant and stored by a consortium. The transaction data 1002 includes a plurality of records 1034. Each record 1034 corresponds to a particular transaction, and each record 1034 includes a plurality of fields 1036. In the depicted example, the fields 1036 include: (i) a transaction ID field 1036a whose value is intended to be a transaction ID that uniquely identifies the transaction, (ii) a date field 1036b whose value is intended to be the date that the transaction took place, (iii) a fraud label field 1036c whose value is intended to indicate whether or not the transaction has been reported as being fraudulent (e.g., a chargeback has been requested), and (iv) a plurality of fields 1036d-f whose values are intended to include various characteristics that are associated with the transaction, such as the payment information that was used to complete the transaction, the IP address of the computing device that was used to complete the transaction, the types of goods or services that were purchased during the transaction, and so forth.

In some embodiments, the consortium can define the fields 1036 for the transaction data 1002, and e-commerce merchants can provide values for some or all of the fields 1036. Some e-commerce merchants may not be able to provide values for all of the fields 1036, and other e-commerce merchants may choose not to provide values for at least some of the fields 1036. If the e-commerce merchants do not provide values for certain fields 1036, those fields 1036 can be stored with null values in the transaction data 1002 that is stored by the consortium.

As indicated above, classifying transaction data can include determining whether the quality of the transaction data exceeds a pre-defined threshold quality level (e.g., the threshold quality level 514a). For the transaction data 1002 shown in FIG. 10, this determination can include identifying how many of the fields 1036 have non-null values. In some embodiments, the threshold quality level can be defined as a certain percentage. If the percentage of the fields 1036 that have non-null values exceeds this percentage, the quality of the transaction data 1002 can be considered to exceed the threshold quality level.

As also indicated above, classifying transaction data can include determining whether the transaction data includes any matured data. For the transaction data 1002 shown in FIG. 10, this determination can include identifying whether any of the records 1034 correspond to transactions that occurred more than a threshold period of time (e.g., the time period 514c) before the current date. This can be determined by comparing the current date with the value of the date field 1036b in the record 1034. If the difference between the current date and the value of the date field 1036b in the record 1034 exceeds the threshold period of time, then the transaction data 1002 can be considered to include at least some matured data.

FIG. 11 illustrates an example in which a matured fraud risk model 1106c can be a multi-layered model. More specifically, the outputs from a family of “small” artificial intelligence (AI) models can be provided as inputs to the matured model 1106c along with machine learning attributes 1165 corresponding to an event. The event can be a potential e-commerce transaction, and the machine learning attributes 1165 can be attributes corresponding to the potential e-commerce transaction (as discussed above).

The AI models 1160, 1161, 1162, 1163, 1164 can be referred to as “small” AI models because they are trained based on the subpopulations of transactions or partial/fuzzy fraud labels. Their risk scores can be used as data attributes for the matured model 1106c, which can further improve the matured model performance.

In the example shown in FIG. 11, the family of small artificial intelligence (AI) models includes a short-term model 1160, a bank authorization model 1161, a manual review model 1162, a device fingerprinting model 1163, and a fraud alert model 1164. The specific small AI models shown in FIG. 11 are provided for purposes of example only, and should not be interpreted as limiting the scope of the present disclosure.

Each of the AI models 1160, 1161, 1162, 1163, 1164 can output indicators (e.g., scores) that a particular event will occur. The short-term model 1160 can be a model that is trained to use the most recent data and labels, and which is mainly used to catch a recent fraud trend. The bank authorization model 1161 can be a model that is mainly used to integrate fraud patterns caught by a bank. The labels for model training can include whether the bank is settled or not (i.e., whether the bank has made a final decision about whether to reject the transaction). The manual review model 1162 can be used if manual review is being used. This model 1162 can be trained based on fraud labels that are identified through manual review. The device fingerprinting model 1163 is a model that is trained only to use device fingerprinting information and all bad labels collected from transaction data with device fingerprinting. The fraud alert model 1164 is the model that is trained only using the bank alert as bad labels. The final, matured model 1106c can include all regular attributes 1165 and the scores from the “small” AI models 1160, 1161, 1162, 1163, 1164 as inputs.

The indicators output by the various AI models 1160, 1161, 1162, 1163, 1164 can be provided as input to the matured model 1106c. The matured model 1106c can output a fraud risk indicator 1132. The fraud risk indicator 1132 that is output by the matured model 1106c can be based on various attributes 1165 associated with the potential e-commerce transaction as well as the fraud risk indicators output by the various AI models 1160, 1161, 1162, 1163, 1164.

The indicators output by the various AI models 1160, 1161, 1162, 1163, 1164 can help improve accuracy of the final, mature model. In some embodiments, indicators from the AI models 1160, 1161, 1162, 1163, 1164 can include estimations of probabilities of different results of the potential e-commerce transaction under consideration. For example, the bank authorization model 1161 can predict the probability whether a bank will reject the transaction. The fraud rate in the bank's rejected population is likely to be much higher than the fraud rate of the settled population. The manual review model 1162 can predict the probability that the potential e-commerce transaction will be considered fraudulent as a result of manual review. The device fingerprinting model 1163 can predict the probability that the potential e-commerce transaction will be considered fraudulent as a result of device fingerprinting information. The fraud alert model 1164 can predict the probability that the potential e-commerce transaction will be considered fraudulent as a result of the bank issuing a fraud alert.

For any transaction T, let A be a certain event associated with T. As an example, A could be that the bank declined a particular transaction T. It is possible to derive the relationship of the probability that T is fraudulent and other conditional probabilities as follows:

$$\begin{matrix}P ( fraud ) = P ( fraud , A ) + P ( fraud , \sim A ) \\ = P ( A ) P ( fraud \vert A ) + [ 1 - P ( A ) ] P ( fraud \vert \sim A ) \\ = P ( A ) [ P ( fraud \vert A ) - P ( fraud \vert \sim A ) ] + P ( Fraud \vert \sim A )\end{matrix} \qquad ( 1 )$$

Equation (1) indicates that the bigger the difference of the fraud rate when an event A happens as compared to when event A does not happen, the more helpful the probability of event A happening is for predicting the probability that the event is fraudulent. The AI models 1160, 1161, 1162, 1163, 1164 predict the probability of different events. The fraud rate for the corresponding transactions is much higher when these events happen as compared to when they do not happen. Therefore, the indicators output by the AI models 1160, 1161, 1162, 1163, 1164 can be used by the final, matured AI model 1106c to improve the accuracy of the fraud risk indicator 1132.

In the above discussion, some aspects of the present disclosure were described in relation to chargebacks. A chargeback is the forced reversal of a credit or debit card payment initiated by the cardholder's bank. A consumer can initiate a chargeback of a transaction that was paid for with a particular credit or debit card by contacting the bank that issued the credit or debit card and filing a substantiated complaint regarding the transaction. Chargebacks differ from traditional refunds because the consumer is asking a bank to forcibly take money from the merchant's account rather than contacting the merchant directly and asking for a refund. Many countries have laws that provide chargeback rights, which are primarily intended for consumer protection. Consumers who are the victims of identity theft can request chargebacks for any fraudulent purchases that are made with their stolen payment information.

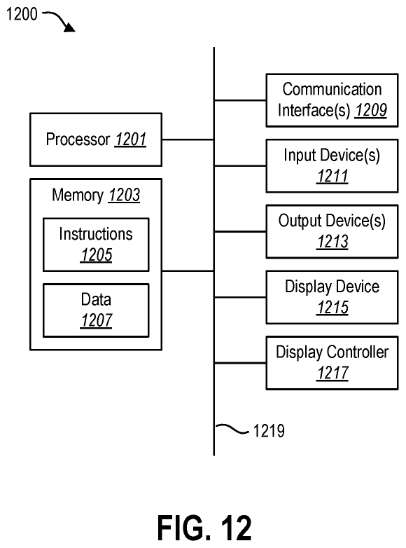

One or more computing devices 1200 can be used to implement at least some aspects of the techniques disclosed herein. FIG. 12 illustrates certain components that can be included within a computing device 1200.

The computing device 1200 includes a processor 1201 and memory 1203 in electronic communication with the processor 1201. Instructions 1205 and data 1207 can be stored in the memory 1203. The instructions 1205 can be executable by the processor 1201 to implement some or all of the methods, steps, operations, actions, or other functionality that is disclosed herein. Executing the instructions 1205 can involve the use of the data 1207 that is stored in the memory 1203. Unless otherwise specified, any of the various examples of modules and components described herein can be implemented, partially or wholly, as instructions 1205 stored in memory 1203 and executed by the processor 1201. Any of the various examples of data described herein can be among the data 1207 that is stored in memory 1203 and used during execution of the instructions 1205 by the processor 1201.

Although just a single processor 1201 is shown in the computing device 1200 of FIG. 12, in an alternative configuration, a combination of processors (e.g., an ARM and DSP) could be used.

The computing device 1200 can also include one or more communication interfaces 1209 for communicating with other electronic devices. The communication interface(s) 1209 can be based on wired communication technology, wireless communication technology, or both. Some examples of communication interfaces 1209 include a Universal Serial Bus (USB), an Ethernet adapter, a wireless adapter that operates in accordance with an Institute of Electrical and Electronics Engineers (IEEE) 1202.11 wireless communication protocol, a Bluetooth® wireless communication adapter, and an infrared (IR) communication port.

A computing device 1200 can also include one or more input devices 1211 and one or more output devices 1213. Some examples of input devices 1211 include a keyboard, mouse, microphone, remote control device, button, joystick, trackball, touchpad, and lightpen. One specific type of output device 1213 that is typically included in a computing device 1200 is a display device 1215. Display devices 1215 used with embodiments disclosed herein can utilize any suitable image projection technology, such as liquid crystal display (LCD), light-emitting diode (LED), gas plasma, electroluminescence, or the like. A display controller 1217 can also be provided, for converting data 1207 stored in the memory 1203 into text, graphics, and/or moving images (as appropriate) shown on the display device 1215. The computing device 1200 can also include other types of output devices 1213, such as a speaker, a printer, etc.

The various components of the computing device 1200 can be coupled together by one or more buses, which can include a power bus, a control signal bus, a status signal bus, a data bus, etc. For the sake of clarity, the various buses are illustrated in FIG. 12 as a bus system 1219.

The techniques disclosed herein can be implemented in hardware, software, firmware, or any combination thereof, unless specifically described as being implemented in a specific manner. Any features described as modules, components, or the like can also be implemented together in an integrated logic device or separately as discrete but interoperable logic devices. If implemented in software, the techniques can be realized at least in part by a non-transitory computer-readable medium having computer-executable instructions stored thereon that, when executed by at least one processor, perform some or all of the steps, operations, actions, or other functionality disclosed herein. The instructions can be organized into routines, programs, objects, components, data structures, etc., which can perform particular tasks and/or implement particular data types, and which can be combined or distributed as desired in various embodiments.

The term “processor” can refer to a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, or the like. A processor can be a central processing unit (CPU). In some embodiments, a combination of processors (e.g., an ARM and DSP) could be used to implement some or all of the techniques disclosed herein.

The term “memory” can refer to any electronic component capable of storing electronic information. For example, memory may be embodied as random access memory (RAM), read-only memory (ROM), magnetic disk storage media, optical storage media, flash memory devices in RAM, on-board memory included with a processor, erasable programmable read-only memory (EPROM), electrically erasable programmable read-only memory (EEPROM) memory, registers, and so forth, including combinations thereof.

The steps, operations, and/or actions of the methods described herein may be interchanged with one another without departing from the scope of the claims. In other words, unless a specific order of steps, operations, and/or actions is required for proper functioning of the method that is being described, the order and/or use of specific steps, operations, and/or actions may be modified without departing from the scope of the claims.

The term “determining” (and grammatical variants thereof) can encompass a wide variety of actions. For example, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there can be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
receiving a request to evaluate a potential e-commerce transaction involving an e-commerce merchant;
selecting a fraud risk model to process transaction information associated with the potential e-commerce transaction, wherein the fraud risk model is selected from among a plurality of possible fraud risk models that could be used to process the transaction information, wherein the fraud risk model is selected based at least in part on quality and maturity of e-commerce merchant data provided by the e-commerce merchant, and wherein the e-commerce merchant data comprises data related to transactions involving the e-commerce merchant;
processing the transaction information using the selected fraud risk model to generate a fraud risk indicator for the potential e-commerce transaction; and
notifying a sender of the request about the fraud risk indicator.

2. The method of claim 1, further comprising calibrating the fraud risk indicator for consistency among the plurality of possible fraud risk models.

3. The method of claim 1, wherein the plurality of possible fraud risk models are designed for members of a consortium, and wherein the plurality of possible fraud risk models comprise:
a starting fraud risk model that is designed for the members of the consortium who do not have any matured data;
an intermediate fraud risk model that is designed for the members of the consortium who have data that has been matured for less than a threshold time period; and
a matured fraud risk model that is designed for the members of the consortium who have data that has been matured for greater than the threshold time period.

4. The method of claim 1, wherein selecting the fraud risk model comprises:
determining that the e-commerce merchant data does not comprise any matured data; and
selecting a starting fraud risk model to process the transaction information.

5. The method of claim 1, wherein selecting the fraud risk model comprises:
determining that the e-commerce merchant data comprises some matured data but less than a threshold time period of the matured data; and
selecting an intermediate fraud risk model to process the transaction information.

6. The method of claim 1, wherein selecting the fraud risk model comprises:
determining that the e-commerce merchant data comprises more than a threshold time period of matured data; and
selecting a matured fraud risk model to process the transaction information.

7. The method of claim 1, further comprising determining that the e-commerce merchant data satisfies a threshold quality level prior to generating the fraud risk indicator.

8. The method of claim 1, further comprising:
providing configuration information associated with the e-commerce merchant, wherein the configuration information indicates the quality and the maturity of the e-commerce merchant data; and
periodically updating the configuration information based on additional e-commerce merchant data received from the e-commerce merchant.

9. The method of claim 1, further comprising:
determining that the e-commerce merchant data provided by the e-commerce merchant does not comprise any matured data; and
training a starting fraud risk model with the e-commerce merchant data provided by the e-commerce merchant.

10. The method of claim 1, further comprising:
determining that the e-commerce merchant data provided by the e-commerce merchant comprises some matured data but less than a threshold time period of the matured data; and
training an intermediate fraud risk model with the e-commerce merchant data provided by the e-commerce merchant.

11. The method of claim 1, further comprising:
determining that the e-commerce merchant data provided by the e-commerce merchant comprises more than a threshold time period of matured data; and
training a matured fraud risk model with the e-commerce merchant data provided by the e-commerce merchant.

12. The method of claim 1, wherein the plurality of possible fraud risk models comprise a matured fraud risk model, and wherein the matured fraud risk model comprises a multi-layered model that accepts inputs from a plurality of other artificial intelligence models.

13. A computer-readable medium comprising instructions that are executable by one or more processors to cause a computing system to:
obtain configuration information associated with an e-commerce merchant, the configuration information indicating a quality level of e-commerce merchant data and an amount of matured data in the e-commerce merchant data, the e-commerce merchant data comprising data related to transactions from the e-commerce merchant;
receive a request to evaluate a potential e-commerce transaction involving the e-commerce merchant;
process transaction information associated with the potential e-commerce transaction using a fraud risk model that is selected from among a plurality of possible fraud risk models based at least in part on the configuration information associated with the e-commerce merchant; and
notify a sender of the request about results from processing the transaction information.

14. The computer-readable medium of claim 13, wherein the plurality of possible fraud risk models are designed for members of a consortium, and wherein the plurality of possible fraud risk models comprise:
a starting fraud risk model that is designed for the members of the consortium who do not have any matured data;
an intermediate fraud risk model that is designed for the members of the consortium who have data that has been matured for less than a threshold time period; and
a matured fraud risk model that is designed for the members of the consortium who have data that has been matured for greater than the threshold time period.

15. The computer-readable medium of claim 13, wherein the instructions are further executable by the one or more processors to cause the computing system to:
determine that the e-commerce merchant data does not comprise any matured data; and
select a starting fraud risk model to process the transaction information.

16. The computer-readable medium of claim 13, wherein the instructions are further executable by the one or more processors to cause the computing system to:
determine that the e-commerce merchant data comprises some matured data but less than a threshold time period of the matured data; and
select an intermediate fraud risk model to process the transaction information.

17. The computer-readable medium of claim 13, wherein the instructions are further executable by the one or more processors to cause the computing system to:
determine that the data provided by the e-commerce merchant comprises more than a threshold time period of matured data; and
select a matured fraud risk model to process the transaction information.

18. The computer-readable medium of claim 13, wherein the instructions are further executable by the one or more processors to cause the computing system to periodically update the configuration information based on additional e-commerce merchant data received from the e-commerce merchant.

19. A system, comprising:
one or more processors;
memory in electronic communication with the one or more processors;
configuration information stored in the memory, the configuration information indicating quality and maturity of data received from an e-commerce merchant;
a plurality of fraud risk models stored in the memory, the plurality of fraud risk models being designed for different phases of data maturity; and
instructions that are executable by the one or more processors to select one of the plurality of fraud risk models to process transaction information associated with a potential e-commerce transaction involving the e-commerce merchant based at least in part on the configuration information.

20. The system of claim 19, wherein the plurality of possible fraud risk models are designed for members of a consortium, and wherein the plurality of possible fraud risk models comprise:
a starting fraud risk model that is designed for the members of the consortium who do not have any matured data;
an intermediate fraud risk model that is designed for the members of the consortium who have data that has been matured for less than a threshold time period; and
a matured fraud risk model that is designed for the members of the consortium who have data that has been matured for greater than the threshold time period.
